(19) United States
(12) Patent Application Publication
(10) Pub. No.: US 2014/0189400 A1
(43) Pub. Date: Jul. 3, 2014

(54) PROCESSING SYSTEM AND ASSOCIATED METHOD

(71) Applicant: MEDIATEK INC., Hsin-Chu (TW)

(72) Inventor: You-Ming Tsao, Taipei City (TW)

(73) Assignee: MEDIATEK INC., Hsin-Chu (TW)

(21) Appl. No.: 13/729,081

(22) Filed: Dec. 28, 2012

(51) Int. Cl. G06F 1/32

(52) U.S. Cl. CPC G06F 1/3225
USPC 713/323

(57) ABSTRACT

The present invention provides a processing system and associated method; the processing system includes a processing unit, a peripheral unit consuming system resource, a support unit capable of providing the system resource, a buffer capable of storing a portion of the system resource, and a system power manager (SPM). When the processing unit suspends for idle, the peripheral unit consumes the buffer and thus does not need system resource from the support unit, so the support unit and/or the corresponding system resource can be powered down. When the buffer is consumed, the SPM is capable of allocating the system resource for the peripheral unit in response to request of the peripheral unit, so the processing unit does not have to leave idle for allocating the system resource.

### FIELD OF THE INVENTION

The present invention relates to a processing system and associated method, and more particularly, to a processing system and associated method achieving improved power-saving by a buffer capable of holding system resources and/or a system power manager (SPM) capable of allocating system resources during idle of processing unit.

### BACKGROUND OF THE INVENTION

A modern electronic device embeds a processor to coordinate peripheral parts of the electronic device. For example, a cellular phone can have a processor to control other peripheral parts such as display, audio amplifier and/or speaker, and radio circuitry for communication.

To cooperate with the peripheral parts, the processor can include a processing unit, one or more support units and one or more peripheral units. Each peripheral unit may interface an associated peripheral part; the processing unit may execute software/firmware codes (e.g., operation system) and accordingly command the peripheral units to control the associated peripheral parts. Each support unit may provide associated system resource for operation of the processing unit and the peripheral units; the processing unit may allocate system resources for the peripheral units by making the support units accessible to the peripheral units.

For example, the processor may include a display controller as a peripheral unit to control the display, may also include an external memory interface (EMI) as a support unit for providing memory space by accessing an external memory, such as a dynamic random access memory (DRAM). To maintain a graphic user interface, the processing unit of the processor may produce a frame (a picture) to be displayed and then stores the frame in the DRAM by the EMI; hence, the display controller can fetch the frame from the DRAM by the EMI and display the frame on the display.

Operations of the processing unit, the peripheral units and the support units consume power. For power-saving, the processing unit can suspend to idle. During idle of the processing unit, however, if a peripheral unit keeps on working (e.g., the display controller maintains a perceptible graphic display), the system resources and the support units providing system resources for the processing unit and the peripheral unit need to remain accessible, so the processing unit may wake up from idle (either spontaneously or by interrupt of the peripheral unit) to allocate system resources for the peripheral unit. Frequently waking the processing unit consumes power. Keeping the system resources and the support units accessible also consumes considerable power; for example, when the system resource is external to the processor, the support units have to communicate with external circuitry through Input/output pads of powerful (and thus power-consuming) drivers. That is, suspending the processing unit alone does not achieve effective power-saving.

### SUMMARY OF THE INVENTION

Therefore, the present invention relates to a processing system and associated method of enhanced power-saving.

An objective of the present invention is to provide a processing system including a processing unit, a peripheral unit, a system power manager (SPM) and a support unit. The processing unit is capable of suspending to idle and capable of waking up from idle. The support unit is capable of being powered up to provide system resource and capable of being commanded to power down the system resource. The peripheral unit is capable of issuing a request to request system resource for operation. During idle of the processing unit, when the peripheral unit does not issue the request, the SPM is capable of commanding the support unit to power down the system resource; when the peripheral unit issues the request, the SPM is capable of allocating the system resource for the peripheral unit in response to the request, e.g., powering up the support unit to provide the system resource for the peripheral unit in response to the request.

In an embodiment, the processing system also includes a buffer coupled to the peripheral unit and capable of storing at least a first portion of the system resource provided by the support unit. The peripheral unit is capable of consuming the first portion stored in the buffer for operation; the peripheral unit is also capable of issuing the request to request a second portion of the system resource, e.g., to request the second portion of the system resource when the first portion left to be consumed is within a predetermined threshold.

In an embodiment, when an idle interval has elapsed after the processing unit starts to suspend, the SPM is further capable of powering up the support unit for the processing unit to access and waking up the processing unit. In an embodiment, the processing system also includes a timer coupled to the SPM, capable of timing passage of the idle interval, and capable of notifying the SPM when the idle interval has elapsed; the SPM is further capable of waking up the processing unit in response to notification of the timer.

With cooperation of the SPM and the timer, enhanced power-saving is achieved. When the processing unit is awake, the processing unit is capable of accessing the support unit, and when the processing unit suspends to idle, the processing unit is further capable of stopping accessing the support unit. That is, during idle of the processing unit, when the peripheral unit is still consuming a first portion of system resource stored in the buffer, both the processing unit and the peripheral unit do not need to access the support unit for system resource, thus the SPM can power down the support unit for power-saving. During idle of the processing unit, when the peripheral unit issues a request for a second portion of system resource from the support unit, the processing unit does not have to wake up, because the SPM is capable of allocating system resource for the peripheral unit by powering up the support unit, so the second portion of system resource can be provided to the buffer. Thus, when the peripheral unit is consuming the second portion in the buffer, the SPM is capable of again powering down the support unit.

The idle interval of the timer can indicate a scheduled update for the system resource of the support unit. During power-down of the support unit, when system resource of the support unit needs to be updated, e.g., when the idle interval elapses after the processing unit starts to suspend, the SPM is capable of powering up the support unit and waking up the processing unit, so the processing unit can update the system resource of the support unit.

In an embodiment, the support unit is an interface to a memory, e.g., a dynamic random access memory (DRAM), so as to provide system resource for storing a frame; the peripheral unit is a display controller, the buffer is a line buffer storing one or more lines of a frame, and the processing unit (e.g. a central processing unit and/or a graphic processing unit) is capable of scheduling the idle interval to update the frame. When the support unit is commanded to power down the system resource, the support unit is capable of setting the DRAM for self-refreshing, hence the support unit itself does not have to consume power for toggling refreshing of the DRAM.

In an embodiment, the peripheral unit is capable of issuing an interrupt to the processing unit for requesting the processing unit to wake up and to allocate the system resource; however, the SPM is further capable of intercepting the interrupt during idle of the processing unit, such that the processing unit does not wake up in response to the interrupt. That is, during idle of the processing unit, the interrupt attempting to wake up the processing unit is transferred to a request to the SPM, so the SPM, instead of the processing unit, will allocate system resource for the peripheral unit. Fewer times the processing unit has to wake, more power is saved.

An objective of the invention is to provide a method for operating aforementioned processing system, including: after the processing unit prepares system resource of the support unit, setting an idle interval, and suspending the processing unit for the idle interval, such that the processing unit does not serve to allocate system resource for the peripheral unit during the idle interval; during the idle interval, commanding the support unit to power down the system resource by the SPM when the peripheral unit consumes a portion of system resource from the buffer and thus does not request system resource from the support unit, and allocating system resource for the peripheral unit (e.g., powering up the support unit) by the SPM in response to a request of the peripheral unit; meanwhile, by the timer, timing passage of the idle interval and notifying the SPM when the idle interval has elapsed; in response to notification of the timer, waking up the processing unit to update system resource of the support unit by the SPM.

By the peripheral unit, request a second portion of the system resource while for example, the first portion left to be consumed is within a predetermined threshold.

While suspending the processing unit during the idle interval, prevent the processing unit from accessing the support unit and the corresponding system resource, such that the support unit and the corresponding system resource can be powered down when the peripheral unit consumes the buffer; in addition, intercept interrupt from the peripheral unit, such that the processing unit does not wake up in respond to the interrupt.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 illustrates a processing system according to an embodiment of the invention; and

FIG. 2 illustrates operation of the processing system shown in FIG. 1 according to an embodiment of the invention.

### DETAILED DESCRIPTION OF PREFERRED EMBODIMENTS

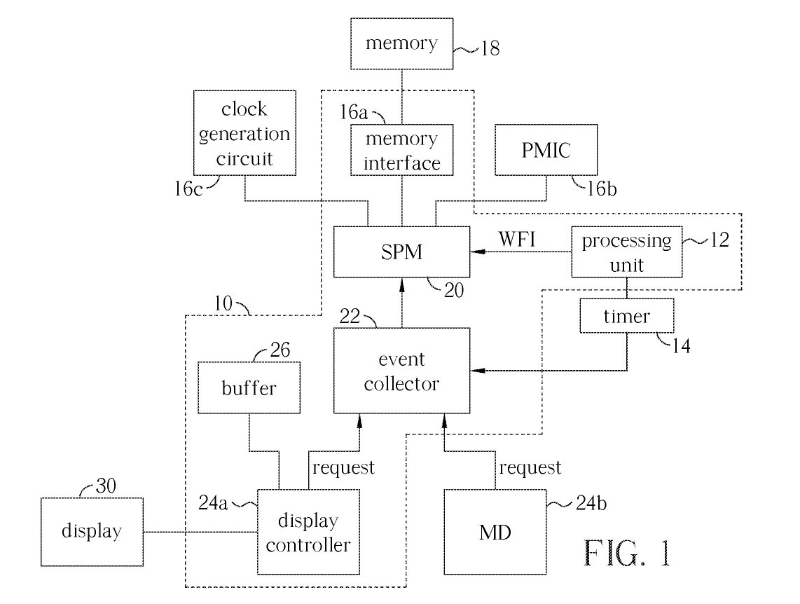

Please refer to FIG. 1 illustrating a processing system 10 according to an embodiment of the invention. The processing system 10 may include a processing unit 12, a timer 14, one or more support units such as the support units 16a to 16c, a system power manager (SPM) 20, an event collector 22, one or more peripheral units such as the peripheral units 24a and 24b, and a buffer 26. The buffer 26 can be an on-chip static random access memory (SRAM). The processing unit 12 can be, for example, a central processing unit of a single core or multiple cores, a micro-controller, a digital signal processing unit, a media processing engine, a video/audio encoder/decoder and/or a graphic processing unit. The processing unit 12 is capable of suspending to idle and being waked up from idle. In some embodiments, the processing unit 12 can wake up from idle by itself. When the processing unit 12 is awake from idle, it is capable of executing software/firmware codes (e.g., operation system) and accordingly capable of coordinating operation of the peripheral units and the support units of the processing system 10.

Each support unit of the processing system 10 is capable of being powered up to provide system resource by internally generating the system resource and/or interfacing externally generated system resource for the processing system 10 to access. System resource may refer to supplies which the processing system 10 needs (consumes) to operate normally and/or to function correctly. Some examples of system resource include controlling/toggling signals and/or clocks, volatile and/or non-volatile memory space(s), stable current(s) and/or voltage(s), as well as electricity power supply. In this embodiment, the support unit 16a can be a memory interface for accessing a memory 18, e.g., a DRAM or any other memory suitable for storing data. The memory 18 can be external or internal to the processing system 10. Thus, the support unit 16a can provide system resource by interfacing data stored in the memory 18. In this embodiment, the support unit 16b can be a power management integrated circuit (PMIC) for providing supply voltages and power as system resource. In this embodiment, the support unit 16c can be a clock generation circuit, e.g., a phase lock loop (PLL), for providing clock(s) as system resource. When the processing unit 12 is awake, it is capable of controlling accessibility and operations of the support units 16a to 16c; for example, the processing unit 12 is capable of adjusting clock rate of the clock(s) provided by the support unit 16c, and adjusting supply voltages provided by the support unit 16b.

In this embodiment, the peripheral unit 24a can be a display controller for controlling an output peripheral part 30, e.g., a display. The display can be a liquid crystal display (LCD), an organic light emitting diode (OLED) display, a touch panel or any other type of display. In this embodiment, the peripheral unit 24b can be a modem (MD) for network communication. The peripheral units 24a to 24b and the processing unit 12 may operate by accessing and consuming system resources provided by the support units 16a, 16b and 16c. The peripheral units 24a to 24b are capable of issuing a request for system resource provided by a support unit. When the processing unit 12 is awake, requests of peripheral units can be interrupts to the processing unit 12, and the processing unit 12 is capable of responding to allocate requested system resource for the requesting peripheral unit. In this embodiment, the buffer 26 can be coupled to the peripheral unit 24a for storing at least a portion of system resource requested by the peripheral unit 24a.

For example, to maintain a graphic user interface by the output peripheral part 30, such as a display, the memory 18 and the buffer 26 can respectively work as a frame buffer and a line buffer. The processing unit 12 is capable of producing (rendering) a frame as system resource for the peripheral unit 24a, and accessing the support unit 16a for storing the frame to the memory 18. When the peripheral unit 24a requests the frame from the support unit 16a, one or more lines of the frame can be fetched from the memory 18 and stored to the buffer 26, and then the peripheral unit 24a can control the output peripheral part 30 to display the line(s) stored in the buffer 26. After the line(s) are consumed (displayed), the peripheral unit 24a is capable of requesting the following line(s) of the frame from the support unit 16a, so the support unit 16a may provide the following line(s) as another portion of the system resource. After all lines of the frame have been consumed, when the graphic user interface needs to refresh to a second frame, the processing unit 12 is capable of producing the second frame to update the system resource for the peripheral unit 24a, thus different portions of the updated system resource can be consumed by the peripheral unit 24a in cooperation with the buffer 26.

Because of the buffer 26, the peripheral unit 24a does not need to access the memory 18 through the support unit 16a when the peripheral unit 24a is consuming the buffer 26; accordingly, the memory 18 can be powered down for a major power saving. In an embodiment, the support unit 16a can also be powered down when the memory 18 is powered down. Alternatively, when the memory 18 is powered down, the support unit 16a can remain powered-up if the support unit 16a also interfaces other memory resources other than the memory 18. Even if the support unit 16a is not powered down, however, powering down the memory 18 can contribute noticeable power-saving.

In a traditional processor without a buffer, because constant resource requirement of the peripheral units, accessibility of system resources have to be maintained, thus system resources and/or the corresponding support units are not allowed to power down. Even if a buffer is available, the processing unit is not allowed to remain idle when system resources stored in the buffer has been consumed and needs to be updated. For the example of implementing graphic user interface, although the processing unit can suspend to idle after generating a frame, idle of the processing unit is not allowed to last till next frame update, since the processing unit is interrupted to wake up from idle by the display controller whenever the display controller requests one or more lines from the memory interface of the memory.

To address power-saving issue, the processing system 10 of the invention can include the SPM 20 and the event collector 22. The SPM 20 can be coupled to the processing unit 12 and the support units 16a to 16c; when the processing unit 12 suspends to idle, such as idle of wait-for-interrupt (WFI) and/or wait-for-event (WFE), the SPM 20 is capable of replacing the processing unit 12 to allocate system resources provided by the support units 16a to 16c for the peripheral units 24a to 24b. That is, when the processing unit 12 enters idle, the SPM 20, instead of the processing unit 12, is capable of controlling accessibility and operation of the support units 16a to 16b. For example, during idle of the processing unit 12, the SPM 20 is capable of powering up the support unit 16a to power up the memory 18 for access (e.g., for updating the buffer 26), and capable of commanding the support unit 16a to power down the memory 18 and powering down the support unit 16a (if possible) whenever the memory 18 does not have to remain accessible (e.g., whenever the buffer 26 is supplying system resource). Rather than full functionality of the processing unit 12, the SPM 20 may focus on a smaller subset related to system resource coordination between the support units and the peripheral units, thus the SPM 20 is of less software/hardware complexity and lower power consumption comparing to the processing unit 12. Note that there may be other low-power states available for the processing unit 12 to suspend besides idles of wait-for-interrupt (WFI) and wait-for-event (WFE). In an embodiment, the support unit 16a and the memory 18 can be controlled by a same state machine with an identical state.

When the SPM 20 is activated during idle of the processing unit 12, the event collector 22 is capable of collecting requests for system resource issued by the peripheral units 24a to 24b, such that the SPM 20 can respond to requests of the peripheral units. In cooperation with the event collector 22, interrupt(s) to the processing unit 12 issued by a peripheral unit to request system resource can be intercepted and transferred to a request to the event collector 22, hence the processing unit 12 does not wake up in response to interrupt; instead, the SPM 20 can respond to requests of the peripheral units.

The timer 14 can be coupled to the processing unit 12 and the event collector 22. Before idle, the processing unit 12 can schedule when to wake up by setting an idle interval, such as a predetermined idle interval, that can be counted by the timer 14. When the processing unit 12 starts to suspend, the timer 14 can also start to count time elapsed. When the idle interval has elapsed after the processing unit 12 suspends to idle, the timer 14 is capable of notifying the SPM 20 via the event collector 22. In response to notification of the timer 14, the SPM 20 is capable of powering up the support units (if they are not powered up) and waking up the processing unit 12, so the processing unit 12 can access system resources required for operation. In an embodiment, the SPM 20 is capable of stopping operating when the processing unit 12 is awake. In another embodiment, the SPM 20 may only power up the processing unit 12 in response to notification of the timer 14, and the awake processing unit 12 can be responsible for powering up the support unit(s) (and/or the memory 18). As the processing unit 12 may require longer time to wake up, it may take a longer time for the supporting unit(s) to restore from power-down if the supporting units are powered up by the processing unit 12.

It is understood that the architecture in FIG. 1 illustrates only one possible embodiment of the invention, other embodiments can also be employed to implement the invention. For example, one or more blocks excluded from the processing system 10 of FIG. 1 can be included in an alternate embodiment of the processing system, as well as one or more blocks included in the processing system 10 of FIG. 1 can be excluded from the alternate embodiment of the processing system. And/or, some blocks shown in FIG. 1 can be integrated as one, and some blocks are optional. For example, the SPM 20 and the event collector 22 may be integrated into one block or circuit. The MD 24b may be optional (and thus may be omitted). WFI notification from the processing unit 12 to the SPM 20 and the notification from the timer 14 to the event collector 22 may be integrated to be transmitted through a same bus.

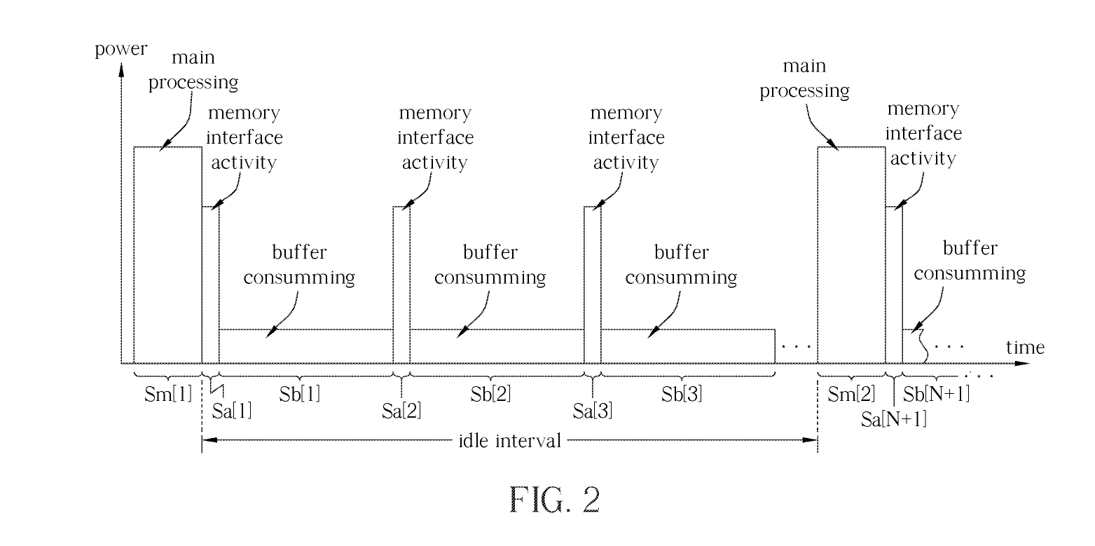

For an example of maintaining a graphic user interface, pleases refer to FIG. 2 which illustrates temporal power usage during operation of the processing system 10 according to an embodiment of the invention. During a stage Sm[1], the processing unit 12 can be awake to generate a first frame, and the support unit 16a can be powered up, so the first frame is stored to the memory 18 by the support unit 16a. As the first frame is generated, the processing unit 12 is capable of scheduling an idle interval and accordingly setting the timer 14, then the processing unit 12 is capable of suspending to idle, and the stage Sm[1] ends. During a next stage Sa[1], the support unit 16a can remain powered up, thus at least a first portion (e.g., one or more lines) of the first frame can be moved to the buffer 26 by cooperation of the support unit 16a and the peripheral unit 24a, and then the stage Sa[1] ends. Because the processing unit 12 may have suspended to idle after the stage Sm[1], power usage of the stage Sa[1] can be lower than that of the stage Sm[1]. In an embodiment, the first portion held by the buffer 26 can be the whole first frame.

Next to the stage Sa[1], the peripheral unit 24a is capable of consuming the first portion of the first frame stored in the buffer 26 (e.g., receiving the first portion from the buffer 26 and transmitting to the display 30 for displaying) during a following stage Sb[1]. The SPM 20, which is responsible for system resource allocation after the stage Sm[1], is therefore capable of commanding the support unit 16a to power down the memory 18 for power saving during the stage Sb[1] (and powering down the support unit 16a if possible), since the idle processing unit 12 and the peripheral unit 24a no longer need accessibility of the corresponding system resource (e.g. memory 18) during the stage Sb[1]. Owing to power-down of the memory 18 (and the support unit 16a), power usage can be greatly decreased during the stage Sb[1]. For the embodiment where the memory 18 is a DRAM, powering down the DRAM can be setting it to self-refresh, and powering up the DRAM can be causing it to leave self-refreshing. Duration of the stage Sb[1] may last hundreds of milliseconds to gain considerable power-saving.

In an embodiment, the processing unit 12, the SPM 20, the peripheral unit 24a and the buffer 16 can be integrated into a same die, while typically the memory 18 and the support unit 16b are respectively located in two other different die(s). That is, the buffer 26 is an embedded memory, e.g., an embedded static random access memory (SRAM), while the support unit 16a and the memory 18 should be accessed through input/output pads (not shown). Thus the support unit 16a and the memory 18 are more power consuming. Therefore, powering down the support unit 16a and the memory 18 gains considerable power-saving. As the memory 18 can be implemented by DRAM which requires refreshing to maintain data storage, the support unit 16a is capable of setting the memory 18 for self-refreshing during the stage Sb[1], hence the support unit 16a does not need to toggle refreshing of the memory 18. The support unit 16a can include isolated registers to maintain control statuses related to the memory 18 when the support unit 16a is powered down.

At the end of the stage Sb[1], when the peripheral unit 24a has consumed the first portion of the first frame (e.g., has displayed the line(s) of the first portion on the output peripheral part 30), the peripheral unit 24a is capable of issuing a request (e.g. an interrupt,) for a second portion of the first frame. The event collector 22 is capable of capturing the request, and the SPM 20 is capable of allocating the second portion for the peripheral unit 24a by powering up the support unit 16a (if the support unit 16a is powered down during stage Sb[1]) and commanding the support unit 16a to power up the memory 18 during a stage Sa[2] following the stage Sb[1]. Note that end of stage Sb[1] can be triggered by various events besides the exemplary event when the first portion has been consumed. After the second portion of the first frame is fetched to the buffer 26 by cooperation of the support unit 16a and the peripheral unit 24a, the stage Sa[2] ends, and the SPM 20 is capable of commanding the support unit 16a to again power down the memory 18 (and powering down the support unit 16a if possible) during a following stage Sb[2], when the peripheral unit 24a consumes the second portion of the first frame.

That is, when the peripheral unit 24a is consuming an n-th portion of the first frame during a stage Sb[n], the memory 18 (as well as the support unit 16a) can be powered down to enhance power-saving. After the peripheral unit 24a has consumed the n-th portion of the first frame or any other proper timing, the SPM 20 is capable of powering up the support unit 16a to power up the memory 18 in response to a request for an (n+1)-th portion of the first frame during a following stage Sa[n+1], so the peripheral unit 24a can continue to consume the (n+1)-th portion of the first frame during a stage Sb[n+1] next to the stage Sa[n+1], and hence the support unit 16a and the memory 18 are again powered down during the stage Sb[n+1].

In an embodiment, the peripheral unit 24a is capable of issuing request for the (n+1)-th portion when the n-th portion left to be consumed is within a threshold, i.e., when non-consumed remainder of the n-th portion is within the threshold. That is, the peripheral unit 24a is capable of issuing the request for the (n+1)-th portion before the n-th portion is completely consumed. Because there may be a latency between when the memory 18 is powered up and when the memory 18 recovers to fully functionality and accessibility, the threshold can be determined according to the latency, such that the (n+1)-th portion can be timely prepared in the buffer 26 by the support unit 16a before or when the n-th portion is completely consumed. For example, the buffer 26 can include a counter to record how many data of the n-th portion are not consumed (e.g., how many data are not read by the peripheral unit 24a); when the counter indicates that data left to be consumed are less than the threshold, the (n+1)-th portion of system resource (e.g., another line) may be requested. That is, the interval between the stages Sa[n] and Sa[n+1] can be dependent on how quickly the n-th portion of system resource is consumed under the threshold.

With repeated cycling of the stages Sa[.] and Sb[.], the peripheral unit 24a can maintain normal functionality (e.g., maintain bright and perceivable graphic user interface) even when the processing unit 12 keeps idle and the memory 18 is powered down. Hence, enhanced power-saving can be achieved without compromise of peripheral functionality. For example, the output peripheral part 30, such as a display, does not have to black out during power-saving cycles of the stages Sa[.] and Sb[.]. Without the buffer 26 and the SPM 20, the memory 18 has to be kept powered up during the stage Sb[.], and power usage of the stage Sb[.] would consequently approximate that of the stage Sa[.], instead of being much lower than that of the stage Sa[.].

The processing unit 12 is capable of scheduling when the first frame needs to be updated to a second frame and capable of accordingly setting the idle interval. For example, an OS (operation system) kernel executed by the processing unit 12 can determine when itself needs to be wakened up and accordingly set up the timer 14. Peripheral event such as screen touch, power key triggered can also be wakeup event. When the timer 14 detects that the idle interval has elapsed after the processing unit 12 starts to suspend to idle, the timer 14 is capable of notifying the SPM 20. Notification from the timer 14 can be received by the event collector 22 as a request to wake up the processing unit 12. In response to the notification, the SPM 20 powers up the support unit 16a to power up the memory 18, and wakes up the processing unit 12. Thus, the processing unit 12 can produce the second frame during a stage Sm[2], and portions of the second frame can be fetched to the buffer 26 and be consumed during following cycling of the stages Sa[.] and Sb[.]. When the graphic user interface only needs to show still or slowly varying images, the idle interval may consequently extends longer; that is, the processing unit 12 may not have to wake up as long as the first frame does not need to be updated.

In addition to saving power during maintenance of graphic user interface, the invention can be generalized for applications where system resource is consumed slower than it is produced. The processing unit 12, operating in faster rates, can first prepare the system resource for a peripheral unit, and then the processing unit 12 can suspend to idle to save power. During idle of the processing unit 12, the peripheral unit can request allocation of at least a portion of system resource and consume the allocated portion in slower rate, and the system resource (and the corresponding support unit) can thus be powered down to save power when the peripheral unit consumes the allocated portion. For example, the peripheral unit can be a functional block to support audio or a network interface block for wired or wireless communication, such as Wi-Fi or Bluetooth. If a system resource is generated by an external module (device/circuit/block) and provided to the processing system by interfacing of a support unit, powering down the system resource may refer to: causing the external module to stop generation of the system resource, to slow down generation of the system resource, to generate the system resource in a slower rate, to stop generation of a portion/subset of the system resource while maintaining generation of another portion/subset of the system resource, to generate less system resource, to update the system resource in a less frequent rate, to change quality and/or quantity of the system resource, and/or to generate alternative kind of system resource different from the system resource generated during power-up. If a system resource is generated by a support unit, powering down the system resource may refer to: causing the support unit to stop generation of the system resource, to slow down generation of the system resource, to generate the system resource in a slower rate, to stop generation of a portion/subset of the system resource while maintaining generation of another portion/subset of the system resource, to generate less system resource, to update the system resource in a less frequent rate, to change quality and/or quantity of the system resource, and/or to generate alternative kind of system resource.

To sum up, with the processing system of the invention (which can include a buffer and a SPM), system resource for peripheral units can be buffered so the power-consuming system resources and/or the corresponding support units (e.g., memory and memory interface) can be powered down, and the processing unit can be allowed to suspend for further power-saving because of the SPM. Enhanced power-saving is therefore achieved without compromise normal functionality of peripheral units. It is understood that CPU is just a possible embodiment of the processing unit. Memory interface, clock generation circuit and PMIC merely list several examples of the support unit. Display controller and modem (MD) are two examples of the peripheral unit. These blocks and associated blocks can be altered to meet design requirements.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A processing system comprising:
a processing unit capable of suspending to idle,
a peripheral unit capable of issuing a request to request system resource for operation, and
a system power manager (SPM) capable of allocating the system resource in response to the request during idle of the processing unit.

2. The processing system of claim 1 further comprising:
a support unit capable of being powered up to provide the system resource,
wherein the SPM is further capable of powering up the support unit in response to the request during idle of the processing unit.

3. The processing system of claim 1 further comprising:
a support unit capable of being powered up to provide the system resource and capable of being commanded to power down the system resource;
wherein during idle of the processing unit, the SPM is further capable of commanding the support unit to power down the system resource when the peripheral unit does not issue the request.

4. The processing system of claim 3 further comprising:
a buffer coupled to the peripheral unit and capable of storing at least a first portion of the system resource provided by the support unit;
wherein the peripheral unit is further capable of consuming the first portion stored in the buffer for operation, and capable of issuing the request to request a second portion of the system resource.

5. The processing system of claim 4, wherein the peripheral unit is capable of issuing the request to request the second portion of the system resource when the first portion left to be consumed is within a predetermined threshold.

6. The processing system of claim 3, wherein the processing unit is further capable of waking up from idle; when the processing unit is awake, the processing unit is capable of accessing the support unit, and when the processing unit suspends, the processing unit is further capable of stopping accessing the support unit.

7. The processing system of claim 6, wherein the SPM is further capable of powering up the support unit for the processing unit to access when an idle interval has elapsed after the processing unit starts to suspend.

8. The processing system of claim 7 further comprising:
a timer coupled to the SPM, capable of timing passage of the idle interval and capable of notifying the SPM when the idle interval has elapsed,
wherein the SPM is further capable of waking up the processing unit in response to notification of the timer.

9. The processing system of claim 3, wherein the support unit is an interface to a dynamic random access memory (DRAM), and the support unit is further capable of setting the DRAM for self-refreshing when the support unit is commanded to power down the system resource.

10. The processing system of claim 1, wherein the peripheral unit is further capable of issuing an interrupt to the processing unit for requesting the processing unit to wake up and to allocate the system resource, and the SPM is further capable of intercepting the interrupt during idle of the processing unit, such that the processing unit does not wake up in response to the interrupt.

11. A method for operating a processing system which comprises a processing unit, a peripheral unit and a system power manager (SPM); and the method comprising:
suspending the processing unit for an idle interval, such that the processing unit does not serve to allocate system resource for the peripheral unit during the idle interval, and
during the idle interval, allocating the system resource for the peripheral unit by the SPM in response to a request of the peripheral unit.

12. The method of claim 11, wherein the processing system further comprises a support unit capable of being powered up to provide the system resource, and the method further comprises:
by the SPM, powering up the support unit in response to the request of the peripheral unit during the idle interval.

13. The method of claim 11, wherein the processing system further comprises a support unit capable of being powered up to provide the system resource and capable of being commanded to power down the system resource, and the method further comprises:
during the idle interval, commanding the support unit to power down the system resource by the SPM when the peripheral unit does not request the system resource.

14. The method of claim 13, wherein the processing system further comprises a buffer coupled to the peripheral unit and capable of storing at least a first portion of the system resource; and the method further comprises:
by the peripheral unit, consuming the first portion stored in the buffer for operation, and requesting a second portion of the system resource.

15. The method of claim 14, wherein the second portion of the system resource is requested when the first portion left to be consumed is within a predetermined threshold.

16. The method of claim 13, wherein the processing unit is further capable of waking up from idle; when the processing unit is awake, the processing unit is capable of accessing the support unit; and the method further comprises:
while suspending the processing unit, preventing the processing unit from accessing the support unit.

17. The method of claim 16 further comprising:
by the SPM, powering up the support unit for the processing unit to access when the idle interval has elapsed.

18. The method of claim 17, wherein the processing system further comprises a timer coupled to the SPM, and the method further comprises:
by the timer, timing passage of the idle interval and notifying the SPM when the idle interval has elapsed,
by the SPM, waking up the processing unit in response to notification of the timer.

19. The method of claim 13, wherein the support unit is an interface to a dynamic random access memory (DRAM), and the method further comprises:
by the support unit, setting the DRAM for self-refreshing when the support unit is commanded to power down the system resource.

20. The method of claim 11, wherein the peripheral unit is further capable of issuing an interrupt to the processing unit for requesting the processing unit to wake up and allocate the system resource, and the method further comprises:
by the SPM, intercepting the interrupt during the idle interval, such that the processing unit does not wake up in respond to the interrupt.
